(19) United States
(12) Patent Application Publication
(10) Pub. No.: US 2012/0310029 A1
(43) Pub. Date: Dec. 6, 2012

(54) SYSTEM AND METHOD TO MITIGATE MIGRATION OF CONTAMINATES

(76) Inventor: Harry V. Lehmann, Novato, CA (US)

(21) Appl. No.: 13/440,767

(22) Filed: Apr. 5, 2012

Related U.S. Application Data
(60) Provisional application No. 61/471,967, filed on Apr. 5, 2011.

(51) Int. Cl. G21F 9/08; G21F 9/20

(52) U.S. Cl. 588/17; 62/259.4

(57) ABSTRACT

System and Method is described that slows the release of contaminated water by rapidly freezing the ground water, including salt water, which permeates the area underneath the a contamination source such as a melted reactor, so that the resulting ice lens mitigates the extent to which radioactive water is released into the environment. The method here described may be used for this purpose through the accomplishment of two goals; first, a resulting reduction in the quantum of radioactive water released, per se, and secondly, a reduction in the level of particulate radiation reaching the environment due to slowed water flow velocities. Cooling channels in thermal contact with the water and soil evaporate a low boiling point liquid in order to cool the proximate water and soil. The low boiling point liquid is supplied by an insulated supply channel. The channels are bored into the earth using known boring/tunneling techniques.

### CROSS REFERENCES

This non-provisional application claims priority benefit of co-pending Provisional application No. 61/471,967 filed Apr. 5, 2011 entitled “Rankine Cycle Ice-Lens Formation With Secondary Cupping as a Meltdown Mitigation Technique in a Water Table,” the entirety of which is hereby incorporated by reference.

### BACKGROUND

The disclosed subject matter is directed to a System and Method for retarding the speed of flow of contaminated water, from a nuclear reactor or other contamination source from which such contaminated water is issuing.

The subject matter uses micro-tunneling, coupled with pipe insertion, coupled with insulated pipe insertion, so that liquids with very low boil points, such as Liquid Nitrogen, or other refrigerant gasses, may be inserted in the liquid state, to vaporize upon release from the insulated containment, so that heat energy is absorbed from the water table, resulting in a reduction in flow rate, thereby impeding the capacity of the water under flow to carry particulate matter.

The subject matter also discloses a “laced” approach, in which twin barreled pipes, as herein set forth, may be inserted an non-conflicting depths, but in such proximity to mutually contribute to water sludge accumulation, ice rime, and, with sufficient evaporation process, the formation of an ice lens, sufficient to retard the escape of contaminated water.

The effect of this System and Method is to slow the release of contaminated water as it is possible to rapidly obtain the freezing the ground water, including salt water, which permeates the area underneath the melted reactors, so that the resulting ice lens will mitigate the extent to which radioactive water is released into the environment. The method here described may be used for this purpose through the accomplishment of two goals; first, a resulting reduction in the quantum of radioactive water released, per se, and secondly, a reduction in the level of particulate radiation reaching the environment due to slowed water flow velocities.

It is advantageous to appreciate the existence of “trenchless excavation” for pipe installation. “Direct Jacking,” and the “Micro-tunneling” are approaches widely deployed in the civil engineering context, and similar approaches are used for waste water treatment pipe installation.

Direct Jacking is a tunneling process whereby a single new pipe is installed in one pass. A bore head begins the tunnel excavation from an access shaft and is pushed along by hydraulic jacks that remain in the shaft. The link to the boring head is maintained by adding jacking pipe between the jacks and the head. By this procedure, the pipe is laid as the tunnel is bored.

Micro-tunneling is defined as a trenchless construction method for installing pipelines. The North American definition of microtunneling describes a method and does not impose size limitations on such method; therefore, a tunnel may be considered a microtunnel if all of the following features apply to construction:

Remote Controlled: The microtunneling boring machine (MTBM) is operated from a control panel, normally located on the surface. The system simultaneously installs pipe as spoil is excavated and removed. Personnel entry is not required for routine operations.

Guided: The guidance system usually references a laser beam projected onto a target in the MTBM, capable of installing gravity sewers or other types of pipelines to the required tolerances, for line and grade.

Pipe Jacked: The pipeline is constructed by consecutively pushing pipes and the MTBM through the ground using a jacking system for thrust.

Continuously supported: Continuous pressure is provided to the face of the excavation to balance groundwater and earth pressures.

The above citations are inserted merely to acquaint the reader with the fact that in the modem context it is possible to obtain rapid remote controlled boring of pipe holes, so as to facilitate installation of pipe suitable for such installation. The remainder of the “ice lens” approach as herein stated are based upon the availability of such boring technology.

No sophisticated explanation of the Rankine Cycle is attempted nor necessary here, but a baseline discussion will speed appreciation for those who have not seen their high school or college texts for a while.

It is understood that it takes energy to convert any type of matter from its liquid state to its vapor state. Rather than getting esoteric, just consider the tea kettle; the kettle and its contents are heated, the boiling point is reached, at the boiling point the water reaches its vapor state, and leaves the kettle. It almost immediately precipitates to what we see as “steam,” although close examination of the spout will show a gap, perhaps we could call it a vapor gap, which is a view through the transparent water in its true vapor state. That water in the vapor state is invisible is known to those who have visited the engine rooms of steam turbine aircraft carriers, where in olden days, when a leak was suspected, a broomstick would be swung before a worker as he walked, as the thin vapor stream would cut the stick in half, thereby saving the man. Those turbines, of course, took immense amounts of fuel to operate, originally fuel oil, later nuclear. Bottom line, to take a fluid to the vapor state requires heat.

Our common experience may cause us to first visualize this as a one-way street of analysis; we apply heat, the fluid eventually reaches the boiling point as a result of the input of the heat, the heat having forced sufficient molecular vibratory activity that the vapor state is reached as a result of the heat. However, as Lord Kelvin taught, the system is a two-way thoroughfare. That is why we have working refrigerators. In that context, the evaporation cycle of a gas, chosen for its low boiling point (an issue which will be shown as relevant to the macro-machine here contemplated for radioactive containment) can, through compression of that gas (thus the “compressor” of a refrigerator) result in the use of the evaporative cycle, which is called the Rankine Cycle, for the extraction of heat, through the forcing of the cycle by compression of the vapor (gaseous state) so that the liquid state is reached, and then the carefully controlled evaporation of the subject liquid, thereby drawing heat at that point of conversion, from the surrounding material world. These are well understood baseline concepts with which all readers of this paper will have been familiar, but it is suggested that a quick review will enhance appreciation of the feasibility of the macro-application as hereafter explained.

These and many other objects and advantages of the present subject matter will be readily apparent to one skilled in the art to which the invention pertains from a perusal of the claims, the appended drawings, and the following detailed description of preferred embodiments.

### BRIEF DESCRIPTION OF THE DRAWINGS

FIG. 1 is a top view of an embodiment of the present subject matter.

FIG. 2 is a side view of an embodiment of the present subject matter.

### DETAILED DESCRIPTION

It is within existing engineering technology to create what amounts to a macro-refrigerator through very carefully sited drilling of the earth around the reactors suffering from meltdown, so as to create an “ice basket” beneath the reactor cores involved. The formation of such an ice lens, or basket in its fullest application, will result in diminished levels of radioactive water reaching the sea. This is what can be done:

One embodiment to prevent such migration of contaminates is the drilling of a multiple twined lateral tunnels beneath the affected reactors. The tunnels, probably six twin bores, should be drilled, first, down at a 45 or so degree angle (or such shallower angle as may be necessary for pipe insertion), to then a level bore, at a drilled position centered below each melting reactor.

For example to use an arbitrary figure of a thousand foot radius from the center of the containment, may define an appropriate balance between exposure avoidance needs and practical necessities relating to the boring and pipe insertion process. Obviously, commencement of operations from a threshold outside the ambit of severe cumulative exposure risks would be wise, but at the edge, so as to minimize the amount of drilling involved.

Preferably the boring should be a downward drilling on a 45 degree angle, to, again, here for illustration, about one hundred feet below or lower than the base of the reactor, or whatever is left of it as in the case of an accident. The construction of the containment grid could also be done preemptively during construction of the reactor or other source of contaminates, or as a matter of course before any such emergency.

There may be a lateral portion. These lateral portions are well within the capacity fairly commonly available robotic pipe insertion drilling equipment as alluded to above. It is suggested that due to various factors, multiple holes should be commenced as equipment and staffing become available.

It is known that 24 inch micro-tunneling is available in industry. For the instant illustrative purposes, it is envisioned using a 18 inch pipe. There should be the insertion of insulated pipe through the resulting tunnel. It is preferable to keep this as simple as possible. There are means of cooling the frontal area of the insertion sans pumping, but believed this to be a bit more complex than likely justified.

Preferably there should be two twin pipes drilled, think of it as a “double barreled” approach. This is necessary because the currently escaping radioactive sea water is at or near sea level, and not solely at lower elevations, though this will of course inevitably become a deepening problem. The desirability for twin bores will be shortly examined.

Upon the insertion of the insulated pipe, which at the least must have telemetry for heat, there should be the insertion of a low boiling point gas. Preferably liquid nitrogen. It is noted that while venting of the nitrogen post use is likely, this need not involve any particulate radiation. There is the need to control the post evaporation venting of the gas, which can involve compression and reuse, however such is not the focus, the focus here will be on cooling, and not re-circulation.

The baseline is that a cold non-explosive gas, here liquid nitrogen may be inserted via a well-insulated interior casing, or pipe, which is in turn inserted inside the pipe originally inserted into the bore. This method mimics a repair method already in wide use for the repair of deteriorated pipe via the insertion of a pipe of lesser dimension, which in current sewer pipe repair scenarios is called “re-lining.”

When spot repairs of old pipe lines, mainly sewers, are no longer viable, local authorities are faced with the problem of rehabilitating or replacing pipelines in the course of time. Replacement has the disadvantage of being very costly and disruptive to urban areas where the largest sewer networks are located.

HOBAS pipes are inserted in the existing pipeline with grout cementing them in place. In view of the savings municipal authorities are now allocating as much as 50% of budgets to rehabilitation. These types of products are ideal for this application being lightweight, corrosion resistant, quality-assured, easily jointed and rigid to resist grouting forces.

It is noted that there are several indications at the HOBAS site of the use of resins to obtain near-perfect interior smoothness, coupled with entire leakage prevention, using modem materials. So long as the bore can be made at a level sufficient that heat ruin of the piping systems here contemplated is avoided (this may ultimately involve “leapfrog” installations of the “pipe basket”), there may and should be the capacity to entirely insulate the low boiling point gas (here, nitrogen) from contact with radioactive fluid. This would result in a clean vent, although the potential for compression and re-circulation (a true “mega-fridge”) is obvious.

In this contemplated system of twin, or paired, bores, each twin bore will have a “nominal” end (where temperatures exterior to the insulation are consistent with ambient OAT), and a “cold end” which will be the area from the point of release just to the near side of bottom dead center from the reactor. It is preferable that the point of N2 release be prior to the position in the pipe directly below bottom dead center of the reactor, so that direct cooling from the N2 can come prior to, or without, pipe insertion directly below the heat source. The reasons for this will be fairly apparent thus no fuller explanation is furthered here.

Thus, half the each pipe is “ambient,” and half of each pipe, from bottom dead center to the exterior gas release (or compression) point, is very cold. This will cause ice to rime upon the pipe, and so long as gas release is continued, cooling of the surrounding rock/water substrate to occur, to the extent that ice will migrate out from the pipe. This is why a twin bore is advantageous, since the result will be cooling all the way from bottom dead center to the surface, with the insulated pipe having been installed from opposing positions on the circle which defines the drill origination circumference around the affected reactor(s). One such installation, of just one twin pipe system, would, if well engineered, result in some reduction of rate of radioactive water loss to the environment, due to water viscosity increase and resulting reduction in velocity of migration. Thus, a resulting “ice lens” beneath the affected reactor.

However, the next set of twin pipe bores, each “fueled” in opposing directions of super-cool liquid insertion, would commence the formation not just of an “Ice Lens” but rather the building up of an ice web, or “Ice Basket” should result. It would be essential to drill each succeeding twin bore system to an elevation above or below all preceding bores, so as to avoid one drilled system from ruining its predecessor. These are matters of intricate field detail, but quite manageable for one of skill in the art.

There are two methods of freezing involved. First, the liquid nitrogen (the world's supply could if necessary be devoted to this, a unifying effort, though I recognize that this as a melodramatic statement) will, at the least, if there is continuation, cause a freezing of the ground water, just because it is a super-cold liquid. However, it will inevitably evaporate, also thus causing “heat drain” from the Rankine process from the surrounding rock/water milieu. If this groundwater freezing is thus brought to equilibrium with the heat output, time will be bought. There are other applications, but there are problems with loss of ductility at every turn. Still, a desperate situation may sometimes only be surmounted through recognition of the need for an inventive approach. As with some other suggestions, this is sent along for reasons of citizenship. Rather than evaluating this, it is suggested that it be forwarded and evaluated by others more formally qualified than the undersigned.

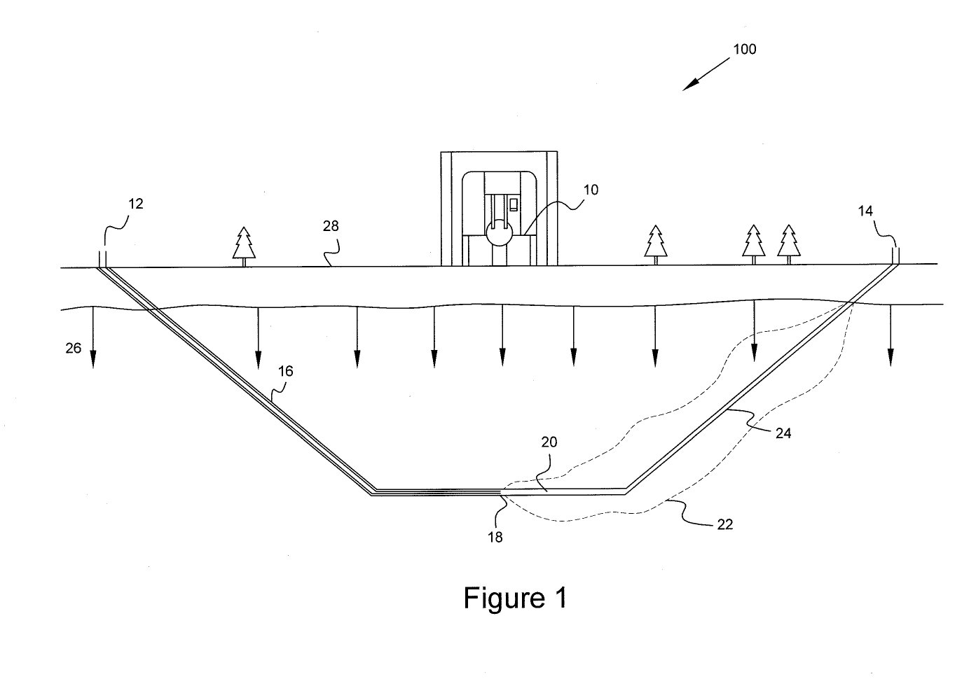

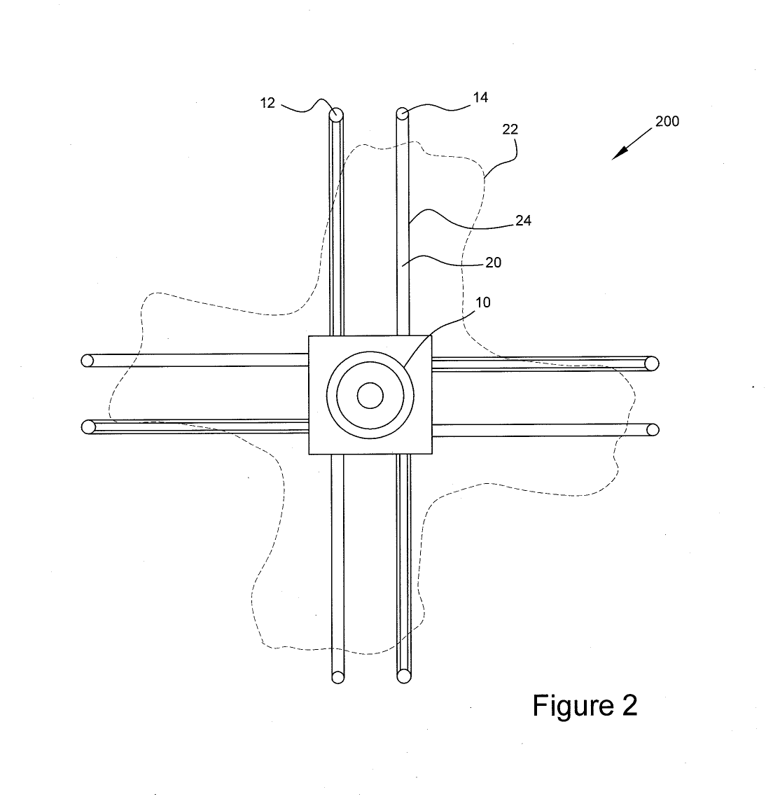

FIGS. 1 and 2 illustrate the proposed drilling, and the results of actuation of the system as herein described. This is a method through which the leakage of radioactive water into the ocean can be reduced in magnitude and stalled at such a reduced rate for a protracted period of time.

FIG. 1 is a side view of an embodiment 100 showing a simple drawing of a nuclear reactor 10 of a general type, the earth 28 upon which it is situated, the water table 26, an inlet casing pipe 12, through which an ultra-low boil point fluid is inserted within an insulated pipe 16, so that, at aperture 18, vaporization of the gas 20 occurs. This results in contact cooling of the soil proximate the cooling channels 24, from the N2, or other chosen refrigerant itself, but also draws heat, from the evaporative cooling process inherent in the involved vaporization. An ice region 22 is thereby produced at the exterior of the casing. Care must be taken to assure that the N2 or other suitable gas is utterly dry, to avoid aperture contamination. Hydraulic process is noted as one possible adjunct to insertion. As noted previously the channels may be formed during the construction of the site and thus other techniques may be available. The potential for capture at vent 14 is recognized, with possible re-compression and delivery of the compressed liquid and gas to the inlet 12 as discussed above. However release to the atmosphere is acceptable if tight seam is obtained, infiltration of the contaminate is avoided, in which case the N2 in the gaseous state would have no toxic character, already being roughly 78% of the ambient air.

FIG. 2 is a top view of an embodiment 200 of the subject matter illustrating the use of multiple non-intersecting pipes, separated by differing but near depth levels, so that, post aperture 18, as to each such pipe, there is cooling effect from the direct contact with the super-cooled liquid form of the N2 (or other) involved, and to a greater effect, continuing up pipe 24 (and in this instance down stream) the vaporization draws heat into the N2, which is then exhausted 14. This results in cooling of the surrounding water, the viscosity increase resulting therefrom thereby slowing velocity, and thereby reducing capacity for the carrying of particulate matter. In addition, with precise modeling before the fact and precise calibration in execution, the overlapping instances of evaporating cooling will cause an ice lens 22 formation below the reactor 10, which should migrate upwards in accordance with the exhaust pipes and their associated cooling effect. A partial ice lens 22 is shown in FIG. 2. It is noted that while these drawings have tended to illustrate the placing of the aperture near bottom dead center, it likely will work better towards ice lens formation if the aperture point is directly below the first encountered edge from the vantage point of the insulated pipe, so that there will be a resulting four cold pipe confluence below the partial melt, so as to assist in ice web propagation. To assist in evaporation, a vacuum may also be created in the cooling channels. Temperature control would be advantageous.

Multiple configurations of the cooling channels are envisioned in defining the boundary of the containment area, such shapes may include bowl shapes, saucer shapes, hyperbolic, parabolic, cylindrical or rectangular shape.

Another aspect of the present subject matter is the uses of throttling of the gas rather than evaporation. In such case a compressed gas would be provided and then expanded through the aperture 18 into the cooling channels 24 at a much lower pressure and temperature.

While preferred embodiments of the present invention have been described, it is to be understood that the embodiments described are illustrative only and that the scope of the invention is to be defined solely by the appended claims when accorded a full range of equivalence, many variations and modifications naturally occurring to those of skill in the art from a perusal hereof.

I claim:

1. A method of restricting the migration of contaminated ground water surrounding a contamination source, comprising:
boring a plurality of vapor exhaust channels to form a containment grid in the ground proximate and underneath the contamination source, said vapor exhaust channels in thermal communication with the ground surrounding the exhaust channels,
boring one or more gas delivery channels said one or more gas delivery channels thermally insulated from the ground surrounding the one or more gas delivery channels,
said plurality of vapor exhaust channels being in fluid communication with at least one of the one or more gas delivery channels,
providing a low boiling point liquid through the one or more gas delivery channels to the plurality of vapor exhaust channels and evaporating the liquid in the vapor exhaust channels to extract heat from the ground surrounding the exhaust channel to cool or freeze the ground water proximate the vapor exhaust channels to thereby restrict migration of contaminated ground water surrounding the contamination source.

2. The method of claim 1, wherein the steps of boring a plurality of vapor exhaust channels and boring one or more gas delivery channels further comprises micro-tunneling.

3. The method of claim 1, wherein the steps of boring a plurality of vapor exhaust channels and boring one or more gas delivery channels further comprises direct jacking.

4. The method of claim 1, wherein the low boiling point liquid is nitrogen

5. The method of claim 1, wherein the low boiling point liquid is ammonia.

6. The method of claim 1, wherein the low boiling point liquid is Freon.

7. The method of claim 1, wherein each of the plurality of vapor exhaust channels is associated with one of the one or more gas delivery channels.

8. The method of claim 1, wherein the evaporated liquid is condensed and returned to the vapor exhaust channels via the one or more gas delivery channels.

9. The method of claim 1, wherein the plurality of vapor exhaust channels and the gas delivery channels are separated by a restrictive aperture.

10. A method of protecting a water table from a nuclear meltdown comprising:
forming a containment grid in the water table proximate a contamination source with a plurality of cooling channels in thermal communication with the water and soil in proximity to the cooling channels and in fluid communication with an insulated supply channel;
forcing a low boiling point liquid into the plurality of cooling channels via the insulated supply channel; and,
evaporating the low boiling point liquid with heat drawn from the water and soil in proximity to the cooling to thereby retard water movement from the containment grid.

11. The method of claim 10, wherein the plurality of cooling channels are pipes inserted into bored channels.

12. The method of claim 11, wherein the insulated supply channels are insulated pipes inserted into bored channels.

13. The method of claim 12, wherein at least one of the cooling channels and insulated supply channels share the same bored channel.

14. A containment system for preventing the migration of fluid from a contaminate source comprising:
a containment grid comprising a plurality of cooling channels, said grid defining a plurality of regions between adjacent cooling channels;
an aggregate comprising frozen water and soil, said aggregate in thermal communication with the plurality of cooling channels and occupying the regions between adjacent cooling channels;
a supply channel thermally insulated from the aggregate;
said supply channel containing a low boiling point liquid and in fluid communication with said cooling channels; and,
said cooling channels containing vapor evaporated from the low boiling point liquid;
wherein said containment grid forms a partial envelope around the contaminate source beneath the ground surface.

15. The system of claim 14, wherein the partial envelope comprises a substantially ally inclined portion and a substantially lateral portion.

16. The system of claim 14, wherein the partial envelope is shaped as a upright bowl.

17. The system of claim 14, further comprising a compressor system in fluid communication with the cooling channels and the supply channel, wherein the vapor is compressed into the low boiling point liquid and provided to the supply channel.
